(19) United States
(12) Patent Application Publication
(10) Pub. No.: US 2006/0113861 A1
(43) Pub. Date: Jun. 1, 2006

(54) Motor vehicle AC generator having a rotor incorporating a field winding and permanent magnets

(75) Inventors: Takuzou Mukai, Handa-shi (JP); Shin Kusase, Oobu-shi (JP)

Correspondence Address: OLIFF & BERRIDGE, PLC, P.O. BOX 19928, ALEXANDRIA, VA, 22320, US

(73) Assignee: Denso Corporation, Kariya-city (JP)

(21) Appl. No.: 11/272,873

(22) Filed: Nov. 15, 2005

(30) Foreign Application Priority Data
Dec. 1, 2004 (JP) 2004-348371

(51) Int. Cl. H02K 1/22

(52) U.S. Cl. 310/263

(57) ABSTRACT

In a vehicle AC generator, the rotor has two pole pieces that axially enclose a field winding, while a tubular stacked-lamination core formed of axially stacked magnetic laminations is mounted with its inner circumference in contact with outer circumferences of the pole pieces. A plurality of axially extending elongated permanent magnets each magnetized in the circumferential direction are implanted in the stacked-lamination core, with adjacent permanent magnets polarized in opposite directions, so that axially extending circumferentially alternating N and S rotor poles are formed at the outer circumferential surface of the stacked-lamination core by the magnetic flux of the field winding.

### CROSS REFERENCE TO RELATED DOCUMENT

This application is based on and incorporates herein by reference Japanese Patent Application No. 2004-348371 filed on Dec. 1, 2004.

### BACKGROUND OF THE INVENTION

1. Field of Application

The present invention relates to an AC generator having a rotor that incorporates a field winding and permanent magnets, for installation in a motor vehicle.

2. Description of Related Art

Types of rotary machine such as an AC generator are known which have a rotor having an axially wound field winding, with claw-shaped pole pieces on the circumference of the rotor, extending axially in opposing directions and enclosing the field winding. Specifically, a set of N-polarity claw-shaped pole pieces (i.e., each having an approximately triangular shape, when the rotor is seen in side view) are enmeshed between, but spaced apart from, a set of S-polarity claw-shaped pole pieces. It has also been proposed to provide permanent magnets on the rotor, disposed between adjacent N- and S-polarity claw-shaped pole pieces in order to reduce a flow of leakage magnetic flux between these, and thereby increase the amount of magnetic flux that flows between the rotor and the stator core. This is described for example in Japanese patent publication No. 61-85045, pages 2 to 3, and FIGS. 1 to 9, referred to in the following as reference document 1

With such a type of rotor, the iron losses that result from eddy current flow at the surfaces of the rotor pole pieces are large. In order to reduce these iron losses, it is known (for example in Japanese patent publication No. 11-150902, pages 3 to 5, and FIGS. 1 to 10, referred to in the following as reference document 2) to reduce these eddy currents by forming each of the claw-shaped pole pieces from laminations of a magnetic material such as steel, stacked along the axial direction of the rotor, with a permanent magnet disposed between each adjacent pair of pole pieces. Alternatively, instead of using such stacked steel laminations to form the claw-shaped pole pieces it is known (for example as described in Japanese patent publication No. 11-206084, pages 3 to 4, and FIGS. 1 to 4, referred to in the following as reference document 3) to reduce these eddy currents by incorporating a third core, extending around the peripheries of the claw-shaped pole pieces, with that third core being formed of stacked steel laminations, and with permanent magnets being implanted within the third core.

In the case of a type of rotary machine in accordance with reference document 2, in which the claw-shaped pole pieces are formed of stacked steel laminations, and a permanent magnet is disposed between each pair of adjacent pole pieces, it may be possible to achieve satisfactory operation if the level of centrifugal force acting on the rotor is small. However when used for a rotary machine in which the rotor must operate at a high speed of rotation, such as a vehicle AC generator, there is a danger of destruction due to the high level of centrifugal force that will act on the rotor.

Furthermore if each of the claw-shaped pole pieces is formed entirely of stacked steel laminations, then due to the fact that the amount of magnetic flux that can flow along the axial direction of the rotor is limited, the amount of magnetic flux that can flow between the rotor and stator is reduced accordingly. In the case of a rotary machine in accordance with reference document 3, each of the claw-shaped pole pieces must engage within a corresponding slot that is formed in the third core, so that a high degree of accuracy is required in forming these pole pieces. Thus, problems arise with respect to ease of manufacture. For example, if the claw-shaped pole pieces are formed by a mass-production manufacturing method such as cold press-forming, the dimensional accuracy of the pole pieces will be low. Hence, gaps may exist between the third core and the pole pieces after these have been inserted into the third core, and this will result in audible noise being generated when the rotary machine is in operation. Alternatively, the pole pieces may be excessively large, and this can result in deformation of the third core when the pole pieces are inserted.

It would be possible to form the claw-shaped pole pieces more accurately by a process such as machining, however this would result in increased manufacturing costs.

### SUMMARY OF THE INVENTION

It is an objective of the present invention to overcome the above problems by providing an AC generator for installation in a vehicle, which can be easily manufactured, and whereby leakage flux that flows within the rotor of the AC generator can be reduced, and eddy currents that flow in the surface of the rotor can also be reduced.

In the following description and in the appended claims, the term “axially extending” when used in referring to components of a rotor is to be understood as signifying “extending along a direction parallel to the (rotation) axis of the rotor”. Similarly, the term “angular position” refers to angles measured by rotation about the rotor axis.

To achieve the above objectives, the invention provides an AC generator for a vehicle, having a stator and a rotor disposed opposite the stator, the rotor including a field winding that is supplied with an electric current for generating a magnetic field to produce a plurality of N poles and a plurality of S poles of the rotor, with the rotor having rotor shaft on which a pair of pole cores are fixedly mounted. The pole cores each are of basically cylindrical form, disposed concentric with the rotor axis. The field winding is mounted between the pole cores. A stacked-lamination core, of tubular shape and formed of laminations of a magnetic material stacked along the axial direction of the rotor, is fixedly mounted on the outer circumferences of the pole cores. The stacked-lamination core is formed with a plurality of axially extending magnet insertion through-holes, each containing one of a set of elongated axially extending permanent magnets (referred to in the following as the first permanent magnets).

Each of the first permanent magnets is magnetized along a circumferential direction of the rotor, and to prevent flux leakage through the stacked-lamination core between the N and S poles of each of the first permanent magnets, each magnet insertion through-hole is shaped and positioned to form axially extending thin-wall regions of the stacked-lamination core between that magnet insertion through-hole and the inner and outer circumferences of the stacked-lamination core.

The first permanent magnets are arranged with the N and S poles of each magnet oriented in the opposite direction to those of the circumferentially adjacent magnet. Hence, each of the N and S poles of the rotor is formed at a region of the stacked-lamination core that is enclosed between a pair of the first permanent magnets. Specifically, each N pole of the rotor is formed at an axially elongated section of the surface of the stacked-lamination core that corresponds to a region of the stacked-lamination core enclosed between two opposing N poles of the first permanent magnets, while each S pole of the rotor is similarly formed at a surface section corresponding to a region of the stacked-lamination core that is enclosed between two opposing S poles of the first permanent magnets.

Such an AC generator also preferably includes a plurality of slots formed in the respective outer circumferences of the first and second pole cores, at respective angular positions that are different from angular positions of the magnet insertion through-holes, and a plurality of second permanent magnets respectively accommodated within the slots, with each of the second permanent magnets being magnetized along a radial direction of the rotor. Specifically, in one of the pole cores, each of these second permanent magnets is located at an angular position between two opposing N poles of the first permanent magnets, while in the other pole core, each of these second permanent magnets is located between two opposing S poles of the first permanent magnets. In that way it is ensured that the magnetic flux produced by the field winding, after passing out of one pole core, will flow through the stator core before returning to the other pole core, and will not flow directly through the stacked-lamination core from one pole core to the other.

Alternatively, the same purpose can be achieved by forming a plurality of U-shaped recessed portions in the outer circumferences of the first and second pole cores, at respective angular positions that are different from angular positions of the magnet insertion through-holes, i.e., each of these U-shaped recessed portions of one pole core being located at an angular position between two opposing N poles of the first permanent magnets, and each U-shaped recessed portion of the other pole core being located between two opposing S poles of the first permanent magnets.

7. An AC generator as claimed in claim 1, comprising;

Furthermore, and AC generator according to the present invention preferably includes a plurality of axially extending iron core insertion through-holes formed in the stacked-lamination core, each located between a circumferentially adjacent pair of the magnet insertion through-holes, and a plurality of iron cores respectively contained in the iron core insertion through-holes. Since each iron core can extend along substantially the entire length of the stacked-lamination core, the flow of magnetic flux (generated by the field winding) along the axial direction can be substantially increased, while the presence of the stacked-lamination core around the iron cores ensures that iron losses due to eddy current flow will be minimal.

When the AC generator incorporates a cooling fan, i.e., formed of one or more vanes, fixedly attached to the rotor by welding, the cooling fan preferably is formed with at least one protrusion for use in performing projection welding, that is located at a radial position corresponding to an interface between respective axial-direction end faces of the stacked-lamination core and of a pole cores. In that way, when the welding is completed, with the cooling fan welded to the rotor at the position of the protrusion, the stacked-lamination core will also have become fixedly attached to a pole core. Hence, the manufacturing process for the AC generator can be simplified.

### BRIEF DESCRIPTION OF THE DRAWINGS

FIG. 1 is a cross-sectional view showing the overall configuration of an embodiment of a vehicle AC generator;

FIG. 2 is an end-on view of a rotor of the embodiment;

FIG. 3 is an end-on view of a tubular rotor core formed of stacked steel laminations;

FIGS. 4A, 4B are respective plan views of a front-end pole core and a rear-end pole core of the rotor of the embodiment;

FIG. 5 is a cross-sectional view taken through a line V-V in FIG. 4B;

FIG. 6 is a cross-sectional view taken through a line VI-VI in FIG. 2;

FIG. 7 is an oblique view of one of a set of iron cores that are incorporated in the rotor of the embodiment;

FIGS. 8A, 8B are partial cross-sectional views for conceptually illustrating the flow of magnetic flux between the rotor and stator of the embodiment, for the case of a front-end pole core and rear-end pole core, respectively;

FIG. 9 is a plan view showing an alternative configuration of a pole core;

FIG. 10 is an end-on view of a rotor which incorporates the alternative configuration of FIG. 9;

FIG. 11 is a diagram illustrating a manner of attaching rotor fans to the rotor of the above embodiment; and

FIG. 12 is an expanded partial cross-sectional view showing details of a permanent magnet within a pole core.

### DESCRIPTION OF PREFERRED EMBODIMENTS

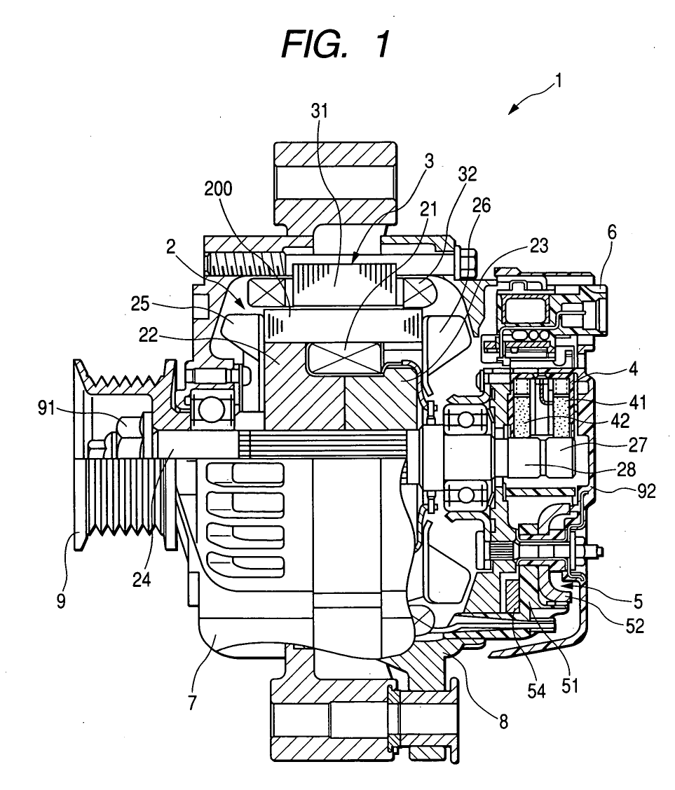

FIG. 1 is a cross-sectional view in elevation showing the general configuration of an embodiment of a vehicle-use AC generator 1, which incorporates internal cooling fans. The AC generator 1 includes a rotor 2, a stator 3, a brush apparatus 4, a rectifier apparatus 5, a voltage controller 6, a drive frame 7, a rear frame 8, a pulley 9, etc. The rotor 2 includes a field winding 21, pole cores 22 and 23, and a rotor shaft 24.

The rotor 2 has a field winding 21 that is wound concentric with the axis of the rotor shaft 24, formed of insulated copper wire that is circular in cross-section. The field winding 21 is axially enclosed between the pole cores 22 and 23, which are formed of a magnetic material and each are of basically cylindrical form as described hereinafter and are fixedly attached with respect to the rotor shaft 24, concentric with the axis of the rotor shaft 24. A stacked-lamination core 200, which is of tubular shape and whose length is substantially equal to the combined axial lengths of the pole cores 22, 23, is mounted on the outer circumferences of the pole cores 22, 23, fixedly attached to the pole cores 22, 23, i.e., with parts of an internal circumferential surface of the stacked-lamination core 200 in contact with outer circumferential surface portions of the pole cores 22, 23. As described hereinafter a plurality of permanent magnets are inserted within apertures provided in the stacked-lamination core 200, which is formed of thin laminations of a magnetic material such as steel (formed with electrically insulated surfaces, as is well known) that are stacked along the axial direction of the rotor shaft 24.

In the following, the term “front” will be used to refer to positions on the rotor 2 that are close to the pulley 9, i.e., at the left side as shown in FIG. 1, while “rear” will be used to refer to positions near the opposite end of the rotor 2. An axial type of cooling fan 25 is fixedly attached by welding to the front end face of the pole core 22, for blowing air in a radial and an axial direction, with intake air coming from the front end of the AC generator 1. A centrifugal type of cooling fan 26 is fixedly attached by welding to the rear end face of the pole core 23, for blowing air in a radial direction, with intake air coming from the rear end of the AC generator 1. Slip rings 27, 28 are mounted on the rear end of the rotor shaft 24, respectively electrically connected to the terminations of the field winding 21. Brushes 41, 42 are mounted within the brush apparatus 4, such as to press against the slip rings 27, 28. An excitation current is supplied from the rectifier apparatus 5 via the slip rings 27, 28 to the field winding 21.

The rear frame 8 has a 3-phase stator winding 32 that is wound in a plurality of slots formed in the stator core 31. The rotor 2 is rotatably mounted between the drive frame 7 and the rear frame 8.

AC current generated by the AC generator 1 is rectified by the rectifier apparatus 5, to obtain an output DC current. The rectifier apparatus 5 includes a terminal section 51, which is internally provided with wiring distribution terminals, and positive-polarity side heat dissipation fins 52 and negative-polarity side heat dissipation fins 54 which enclose the terminal section 51 with a fixed separation from it. The rectifier apparatus 5 further includes a plurality of positive-polarity rectifier elements (e.g., three elements, respectively corresponding to the three phases of the stator winding 32) which are attached to the positive-polarity side heat dissipation fins 52, and a plurality of negative-polarity rectifier elements which are attached to the negative-polarity side heat dissipation fins 54.

The voltage controller 6 serves to control the level of excitation current that flows in the field winding 21. Specifically, the voltage controller 6 performs successive on/off switching of the supply of excitation current to the field winding 21, with an appropriate duty ratio for maintaining the output voltage from the rectifier apparatus 5 at a constant value, irrespective of changes in the electrical load supplied by the AC generator 1.

The pulley 9, which transmits rotation of a vehicle engine ((not shown in the drawings) to the rotor 2, is fixedly bolted to the front end of the rotor shaft 24 by a nut 91. A rear cover 92 is attached to the vehicle-use AC generator 1, for covering the brush apparatus 4, the rectifier apparatus 5 and the voltage controller 6.

The rotor 2 is driven in a predetermined direction of rotation by rotational force transmitted from the vehicle engine to the pulley 9 by a drive belt, etc. Immediately prior to starting the engine, a DC excitation voltage is applied to the field winding 21 from an external source, causing magnetic excitation of the pole core 22 and pole core 23 with mutually opposite polarities, and thereby producing a plurality of peripheral magnetic poles on the rotor 2 as described hereinafter. A 3-phase AC current is thereby generated by the stator winding 32, resulting in a rectified output current starting to be produced from the rectifier apparatus 5. Thereafter the output voltage from the rectifier apparatus 5 is applied through the voltage controller 6 to the field winding 21 as the excitation voltage, with the external supply of voltage being disconnected.

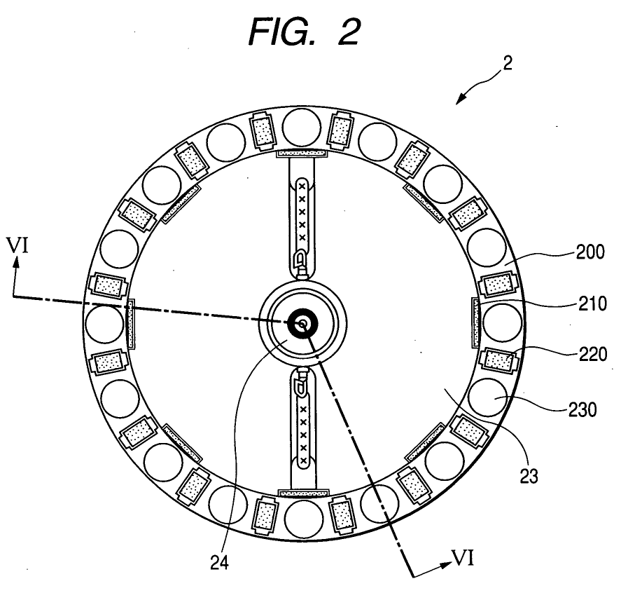

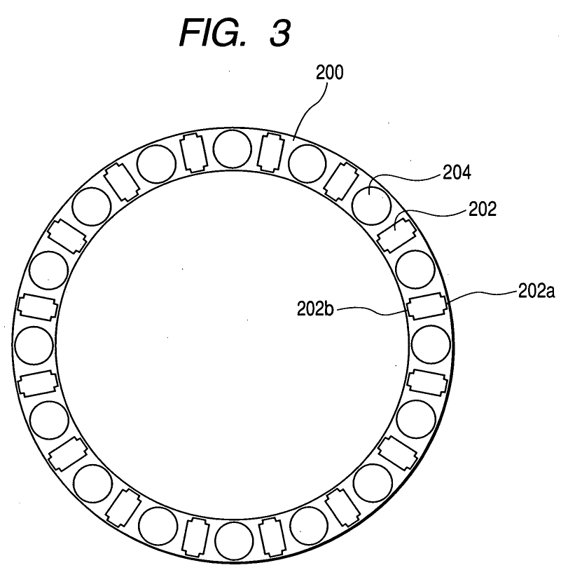

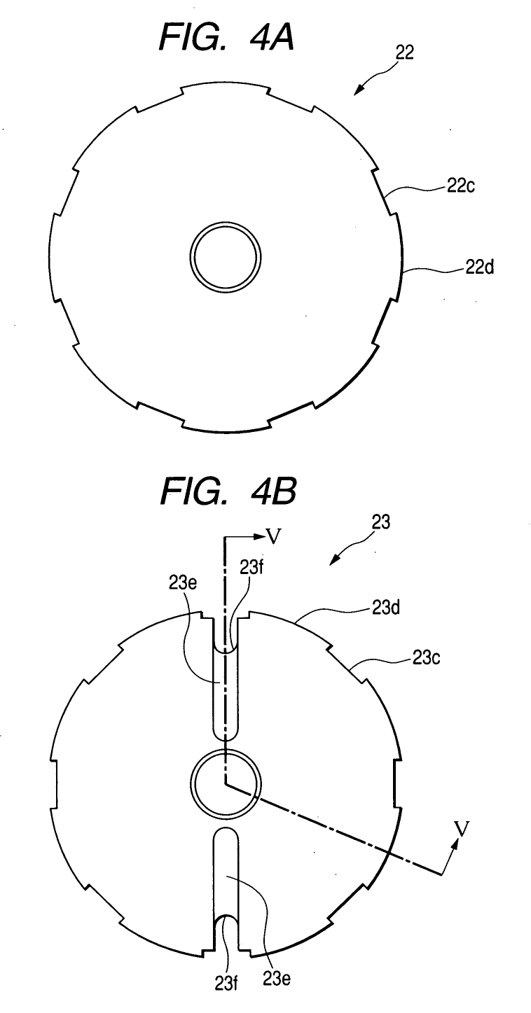

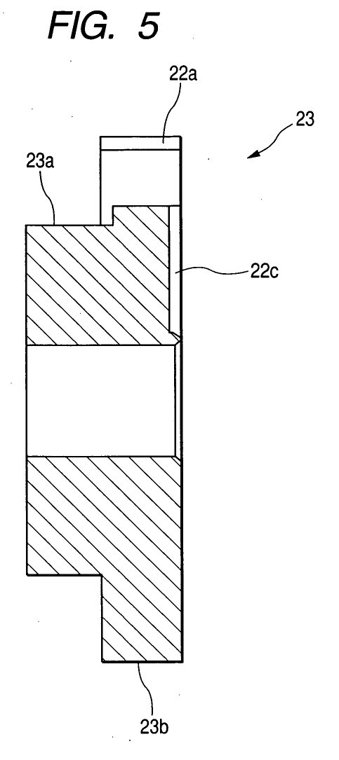

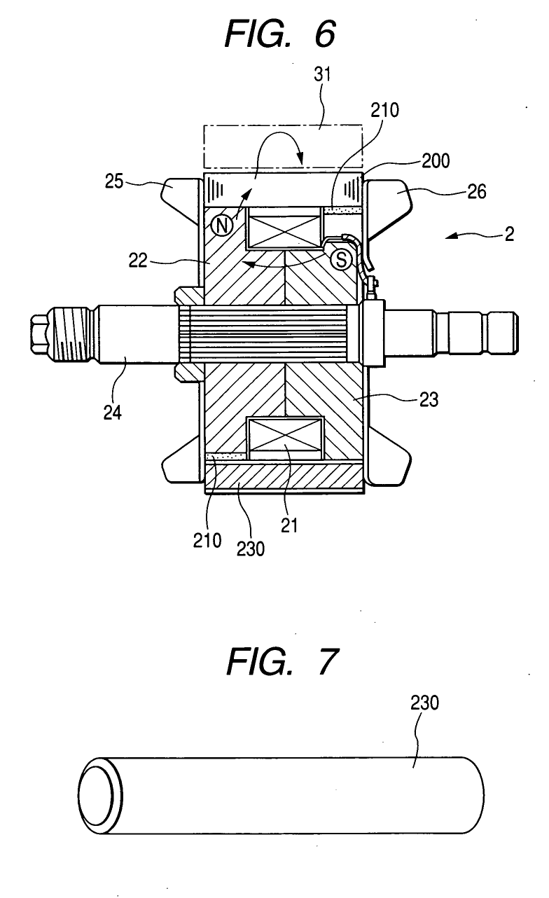

The rotor 2 will be described in greater detail in the following, referring to FIGS. 2 to 6. FIG. 2 is an end-on view of the rotor 2, as seen from the rear end. FIG. 3 is a corresponding plan view of the stacked-lamination core 200 of the rotor 2. FIG. 4A is a plan view of the pole core 22, as seen from the front end, while FIG. 4B is a corresponding plan view of the pole core 23, as seen from the rear end. FIG. 5 is a cross-sectional view of the pole core 23, taken through lines V-V in FIG. 4B, while FIG. 6 is a cross-sectional view of the rotor 2, taken through lines VI-VI in FIG. 2.

As shown in FIG. 5, the pole core 23 is formed with a stepped configuration, having a large-diameter cylindrical section 23b and a small-diameter cylindrical section 23a, each with an outer diameter that is substantially equal to the inner diameter of the stacked-lamination core 200. As shown, the pole core 23 is not formed with prior art types of claw-shaped pole pieces, but has a simple, basically cylindrical shape. The pole core 22 is of similar configuration to the pole core 23, but does not incorporate radially inward-extending slots 23f and grooves 23e (described hereinafter) that are formed on the pole core 23. During assembly of the rotor 2, the small-diameter section 23a and the corresponding small-diameter section of the pole core 22 are brought together in conjunction with the field winding 21, disposed respectively concentrically, such that the field winding 21 surrounds the combined small-diameter sections of the pole core 22 and pole core 23 and becomes axially enclosed between the large-diameter section 22b of the pole core 23 and the corresponding large-diameter section of the pole core 22, as illustrated in FIG. 6.

A plurality of slots (with this embodiment, eight rectangular slots) 23c are formed in the outer circumference of the pole core 23, with a fixed circumferential pitch, as shown in FIG. 4B. An identical set of circumferential slots 22c are formed in the aforementioned large-diameter section of the pole core 22 as shown in FIG. 4A, with the same pitch as for the slots 23c of the pole core 23, but angularly displaced by ½ pitch with respect to the slots 23c.

Thus when the stacked-lamination core 200 is mounted on the pole cores 22, 23, the inner circumferential surface of the stacked-lamination core 200 is held pressed in contact with respective outer circumferential surfaces of the pole cores 22, 23 (specifically, circumferential surfaces of the aforementioned large-diameter cylindrical sections of the pole cores 22, 23) at portions 22d, 23d of these circumferential surfaces, i.e., other than at the positions of the circumferential slots 22c, 23c.

With the stacked-lamination core 200 mounted on the pole cores 22, 23, each of the circumferential slots 22c, 23c accommodates a corresponding one of a plurality of permanent magnets 210.

In addition, the outer circumference of the pole core 23 (specifically, the circumference of the cylindrical section 32b) is formed with two radially extending slots 23f, which in this embodiment each extend to a greater depth than the slots 23c, and two grooves 23e, formed in the rear face of the pole core 23, extending radially from the outer circumference of the 23bx and respectively coinciding in angular position with the slots 23f. The connecting leads between the field winding 21 and the slip rings 27, 28 are passed through these slots 23f and grooves 23e (which are formed only on the pole core 23).

Referring to FIGS. 2 and 3, a plurality of magnet through-holes 202 (with this embodiment, a total of 16) are formed as respective axially extending through-holes in the stacked-lamination core 200, and respective elongated permanent magnets 220 are inserted within these magnet through-hole 202. The length of each of the permanent magnets 220 is substantially identical to the axial length of the stacked-lamination core 200. In addition, a plurality of axially extending iron core through-holes 204, equal in number to the magnet through-hole 202, are formed in the stacked-lamination core 200, each located between a pair of the magnet through-holes 202, and respective iron cores 230, each of elongated cylindrical shape as shown in the oblique view of FIG. 7, are inserted within these iron core through-hole 204. The length of each of the iron cores 230 is substantially identical to the axial length of the stacked-lamination core 200. Each of the slots 23c is located at an angular position that is between a mutually adjacent pair of the iron core through-holes 204.

A magnetic circuit that is formed by the stacked-lamination core 200 and the stator core 31 has a magnetic flux component that passes through the stacked-lamination core 200 along the axial direction. The incorporation of the iron core 230 within the iron core through-hole 204 serves to reduce the amount of magnetic resistance to that flow of magnetic flux.

The magnet through-holes 202 and iron core through-holes 204 are disposed alternately around the circumference of the rotor 2, each with an identical circumferential pitch, which constitutes the pole pitch of the rotor 2 (equal to the pole pitch of one phase of the stator core 31). Each of the magnet through-holes 202 has an elongated rectangular shape in cross-section, with the elongation axis extending radially, as shown in FIG. 3, and with the cross-sectional shape having two radially opposing recesses. As a result, two axially extending thin-wall regions 202a and 202b are formed between each magnet through-hole 202 and the outer circumference and inner circumference, respectively, of the stacked-lamination core 200. These thin-wall regions 202a and 202b serve to reduce the amount of magnetic flux leakage that arises between the N and S poles of each permanent magnet 220 that is inserted within a magnet through-hole 202. Each of the permanent magnets 220 has an elongated rectangular shape in cross-section, that is matched to the shape of each magnet through-hole 202 (other than for the aforementioned recesses). As illustrated in the expanded partial cross-sectional view of FIG. 12, each thin-wall region 202a is disposed opposite a radially outward surface 220a of a permanent magnet 220, and each thin-wall region 202b is disposed opposite a radially inward surface 220b of a permanent magnet 220.

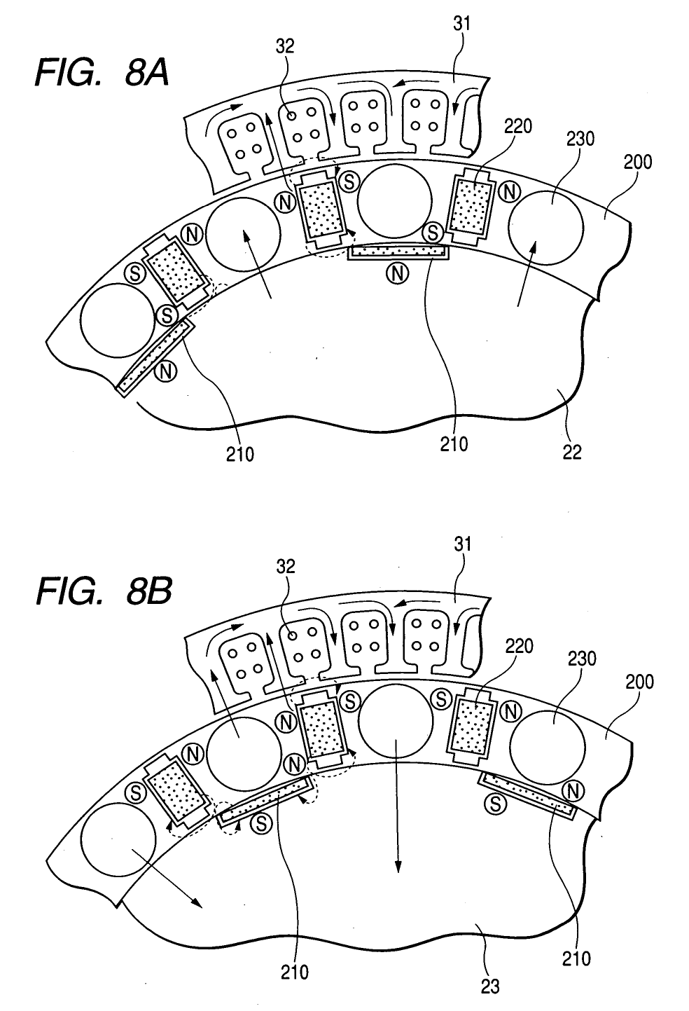

Each of the permanent magnet 220 is magnetized in the circumferential direction of the rotor 2, with the polarization directions of each adjacent pair of permanent magnet 220 being mutually opposite, as shown in the conceptual partial views of FIGS. 8A, 8B, which illustrate the magnetic flux relationships in the rotor 2 as described hereinafter.

A permanent magnet 210 is inserted into each of the rectangular circumferential slots 22c, 23c of the pole core 22 and pole core 23, with each permanent magnet 210 being magnetized in the radial direction of the rotor 2. It will be assumed that with this embodiment (as illustrated in FIG. 6) the effect of the excitation of the field winding 21 is to magnetize the pole core 22 with N polarity and the pole core 23 with S polarity. In that case, as shown in FIGS. 8A, 8B, each permanent magnet 210 of the pole core 22 has its N pole oriented to the radially inward side and its S pole oriented to the radially outward side, while conversely, each permanent magnet 210 of the pole core 22 has its N pole oriented to the radially outward side and its S pole oriented to the radially inward side.

FIGS. 8A, 8B are partial cross-sectional views respectively corresponding to the pole cores 22 and 23, which conceptually illustrate the directions of magnetic flux flow between the rotor 2 and the stator core 31, when an excitation current is being supplied to the field winding 21.

It can thus be understood that each N pole of the rotor 2 (from which magnetic flux flows into the stator core 31 as illustrated by the arrow lines in FIGS. 8A, 8B) is formed at an axially extending section of the outer circumference of the stacked-lamination core 200 that corresponds to a region of the stacked-lamination core 200 enclosed between opposing N poles of two mutually adjacent permanent magnets 220. Similarly, each S pole of the rotor 2 (into which magnetic flux flows from the stator core 31, as illustrated in FIGS. 8A, 8B) is formed at an axially extending section of the outer circumference of the stacked-lamination core 200 that corresponds to a region of the stacked-lamination core 200 enclosed between opposing S poles of two mutually adjacent permanent magnets 220.

As a result of providing the permanent magnets 210, each disposed at the inner circumference of the stacked-lamination core 200, it is ensured that magnetic flux produced by the field winding 21, which flows from the pole core 22 (as illustrated in FIG. 6) into iron cores 230 will not the flow along each iron core 230 to then directly enter the pole core 23, thus by-passing the stator core 31. Instead, the magnetic flux of the pole core 22 first flows into an iron core 230 that does not have a corresponding circumferentially adjacent permanent magnet 210 in the pole core 22, then flows through the stator core 31, and passes from the stator core 31 into a iron core 230 which does have a corresponding circumferentially adjacent permanent magnet 210 in the pole core 22 (i.e., and so does not have a corresponding circumferentially adjacent permanent magnet 210 in the pole core 23) to thereby enter the pole core 23.

In that way, a plurality of axially extending, circumferentially alternating N, S rotor poles are formed in the rotor 2, without requiring the provision of claw-shaped pole pieces on the rotor. Thus, the outer circumferential surface of the rotor, i.e., of the stacked-lamination core 200, can be completely smooth. Since the stacked-lamination core 200 is formed of axially stacked steel laminations, the level of eddy current flow in the surface of the rotor 2 can be made small, however due to the provision of the iron cores 230, there is a low amount of magnetic resistance to the flow of magnetic flux along the axial direction of the rotor 2. Hence, the stacked-lamination core 200 is utilized efficiently for forming the rotor poles and for transferring magnetic flux between the rotor and the stator core.

Moreover, by comparison with a type of rotor which utilizes claw-shaped pole pieces, the construction of the rotor 2 is simple, and the resonance frequency of the rotor 2 can be readily made high by comparison with the maximum speed of rotation at which the vehicle-use AC generator 1 will be operated. Hence, the problem of audible noise due to vibration of the rotor, which can occurs with the type of rotor that utilizes claw-shaped pole pieces, does not occur.

Furthermore, by providing the radially opposing thin-wall regions 202a, 202b in the stacked-lamination core 200 as described above referring to FIG. 3, the amount of leakage magnetic flux that flows through the stacked-lamination core 200 between the N and S poles of each permanent magnet 220 can be made small, thereby enhancing the effectiveness of these permanent magnets in confining the flow of magnetic flux between the pole core 22 and pole core 23 to form the N and S poles of the rotor 2. In addition, due to the fact that the circumferentially oriented magnetic polarization directions of each adjacent pair of permanent magnets 220 are mutually identical, there is a minimal amount of magnetic flux leakage between respective permanent magnets 220.

Furthermore, as a result of forming the circumferential slots 23c at angular positions around the pole cores 22, 23 that are different from the angular positions of the magnet through-holes 202 (shown in FIG. 3), with the permanent magnets 220 being respectively accommodated within the circumferential slots 23c, it is ensured that part of the magnetic flux generated by the field winding 21 will not flow directly between the pole core 22 and the pole core 23 through the iron cores 230 (thereby bypassing the stator core 31). It is thus ensured that substantially all of the outer surface of each elongated region of the stacked-lamination core 200 that is disposed between an adjacent pair of permanent magnets 220 will effectively function as a rotor N pole or S pole.

Furthermore, due to the fact that an iron core through-hole 204 is located between each adjacent pair of the magnet through-holes 202, with an axially extending iron core 230 being contained within each iron core through-hole 204, the magnetic resistance along the axial direction of the rotor is reduced, by comparison with a configuration in which only axially stacked laminations are utilized. Thus the amount of magnetic flux that flows between the rotor 2 and the stator 3 is increased accordingly.

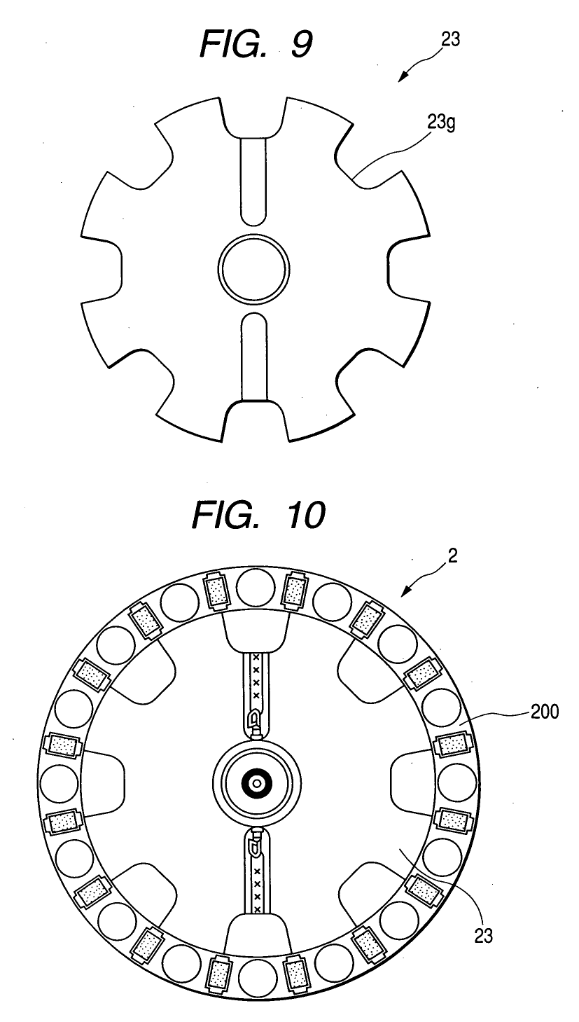

It should be noted that the present invention is not limited to the above embodiment, and that various modifications or alternative configurations could be envisaged, that fall within the scope claimed for the present invention. For example, with the above embodiment, permanent magnets 210 are disposed within the slots 23c that are formed in the respective outer circumferences of the pole cores 22, 23, however it would be equally possible to omit the permanent magnets 210, and instead to form large U-shaped recesses in these outer circumferences of the pole cores 22, 23. This is illustrated in the plan view of FIG. 9, for the case of the pole core 23, in which the angular positions of the large U-shaped recesses 23g correspond to those of the circumferential slots 23c of the pole core 23 of the above embodiment. The pole core 22 is similarly modified. FIG. 10 is a corresponding end-on view of the modified pole core 23, as seen from the rear end. In this case, the large U-shaped recesses 23g perform the same function as the permanent magnets 210 of the above embodiment, serving to block any flow of magnetic flux directly between the pole cores 22 and 23 through the stacked-lamination core 200 the iron cores 230.

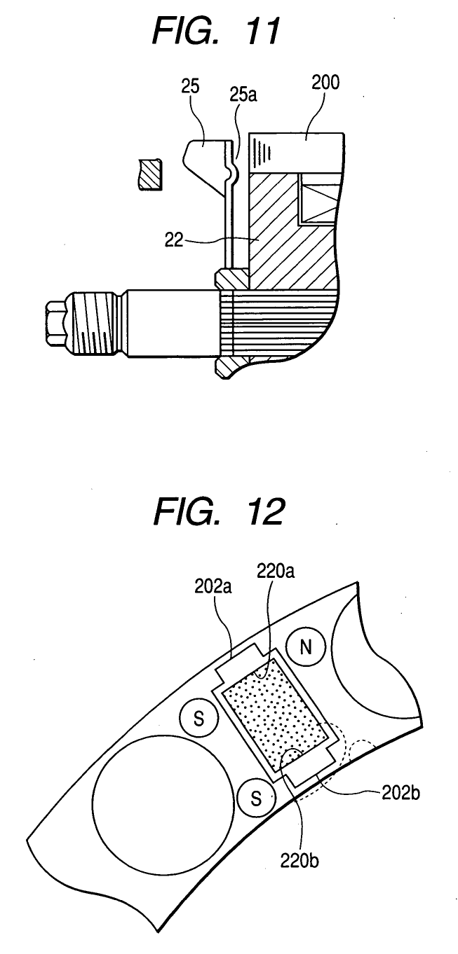

The method of attaching the cooling fans 25, 26 has not been described in the above. As illustrated in FIG. 11 for the case of the cooling fan 25, this embodiment utilizes an advantageous method of attachment, whereby a protrusion 25a is formed on the cooling fan 25 at a radial position that corresponds to the position of the interface between the inner circumference of the stacked-lamination core 200 and the outer circumference of the pole core 22. Projection welding is then employed to weld the protrusion 25a to that interface, thereby attaching the cooling fan 25 to the pole core 22 while at the same time attaching the stacked-lamination core 200 to the pole core 22. The cooling fan 26 is similarly attached by projection welding to the pole core 23 and the stacked-lamination core 200. In that way, simplified manufacture can be achieved.

What is claimed is:

1. An AC generator for a vehicle, having a stator and a rotor disposed opposite the stator, the rotor including a field winding that is supplied with an electric current for generating a magnetic field to produce a plurality of N poles and a plurality of S poles of said rotor, wherein said rotor comprises:
a pair of pole cores fixedly mounted on said rotor, each disposed concentric with an axis of said rotor, with said field winding disposed between said pole cores,
a stacked-lamination core that is of tubular shape and formed of laminations of a magnetic material stacked along an axial direction of said rotor, and is fixedly mounted on respective outer circumferences of said pole cores, said stacked-lamination core being formed with a plurality of axially extending magnet insertion through-holes, and
a plurality of first permanent magnets respectively inserted in said magnet insertion through-holes.

2. An AC generator as claimed in claim 1, wherein each of said magnet insertion through-holes is shaped and positioned within said stacked-lamination core to form respective axially extending thin-wall regions of said stacked-lamination core, between said magnet insertion through-hole and an outer circumference of said stacked-lamination core and between said magnet insertion through-hole and said inner circumference of said stacked-lamination core.

3. An AC generator as claimed in claim 1, wherein each of said first permanent magnets is magnetized along a circumferential direction of said rotor, with adjacent pairs of said first permanent magnets being oriented mutually opposite polarity, whereby each of said N and S poles of said rotor is formed at a surface of a region of said stacked-lamination core that is enclosed between an adjacent pair of said first permanent magnets.

4. An AC generator as claimed in claim 1, comprising:
a plurality of slots formed in respective outer circumferences of said first pole core and second pole core, at respective angular positions that are different from angular positions of said magnet insertion through-holes, and
a plurality of second permanent magnets respectively accommodated within said slots, each of said second permanent magnets being magnetized along a radial direction of said rotor.

5. An AC generator as claimed in claim 1, comprising:
a plurality of U-shaped recesses formed in respective outer circumferences of said first pole core and second pole core, at respective angular positions that are different from angular positions of said magnet insertion through-holes.

6. An AC generator as claimed in claim 1, comprising;
a plurality of axially extending iron core insertion through-holes formed in said stacked-lamination core, each of said iron core insertion through-holes being located between a circumferentially adjacent pair of said magnet insertion through-holes, and
a plurality of axially extending iron cores, respectively contained in said iron core insertion through-holes.

7. An AC generator as claimed in claim 1, wherein said AC generator includes a cooling fan which is fixedly attached by projection welding to said rotor and
said cooling fan comprises at least one protrusion for use in effecting said projection welding, said protrusion being located at a radial position that corresponds to an interface between respective axial-direction end faces of said stacked-lamination core and of one of said first and second pole cores.

8. An AC generator for a vehicle, having a stator and a rotor disposed opposite the stator, the rotor including a field winding that is supplied with an electric current for generating a magnetic field to produce a plurality of N poles and a plurality of S poles of said rotor, wherein said rotor comprises:
first and second pole cores fixedly mounted on said rotor, formed with respective disk-shaped portions that are of identical outer diameter and are disposed concentric with an axis of said rotor, said field winding being axially enclosed between said disk-shaped portions,
a stacked-lamination core that is of tubular shape and formed of laminations of a magnetic material stacked along the direction of said rotor axis, said stacked-lamination core being fixedly mounted on respective outer circumferences of said disk-shaped portions of said pole cores, and formed with a plurality of axially extending magnet insertion through-holes that are spaced apart with a fixed circumferential pitch, and
a plurality of first permanent magnets respectively inserted in said magnet insertion through-holes, each extending along substantially an entire axial length of said stacked-lamination core;
each of said first permanent magnets being magnetized along a circumferential direction of said rotor, with each of said first permanent magnets having an N pole thereof disposed circumferentially opposite an N pole of an adjacent one of said first permanent magnets, and having an S pole thereof disposed circumferentially opposite an S pole of an adjacent one of said first permanent magnets,
each of said N poles of said rotor being produced at an axially extending surface section of said stacked-lamination core corresponding to a region of said stacked-lamination core that is enclosed between two opposing N poles of said first permanent magnets, and each of said S poles of said rotor being produced at an axially extending surface section of said stacked-lamination core corresponding to a region of said stacked-lamination core that is enclosed between two opposing S poles of said first permanent magnets.

9. An AC generator as claimed in claim 8, wherein each of said magnet insertion through-holes is shaped and positioned within said stacked-lamination core to form respective axially extending thin-wall regions of said stacked-lamination core between said magnet insertion through-hole and an outer circumference of said stacked-lamination core and between said magnet insertion through-hole and an inner circumference of said stacked-lamination core.

10. An AC generator as claimed in claim 8, comprising:
a first set and a second set of slots, said first set formed in an outer circumference of said disk-shaped portion of said first pole core and said second set formed in an outer circumference of said disk-shaped portion of said second pole core, each slot of said first set being angularly located between opposing N poles of an adjacent pair of said first permanent magnets, and each slot of said second set being angularly located between opposing S poles of an adjacent pair of said first permanent magnets, and
a plurality of second permanent magnets, respectively inserted within said slots;
wherein each of said second permanent magnets inserted within said slots of said first set has N and S poles thereof oriented respectively radially outward and radially inward, and each of said second permanent magnets inserted within said slots of said second set has S and N poles thereof oriented respectively radially outward and radially inward.

11. An AC generator as claimed in claim 8, comprising: a first set and a second set of U-shaped recesses, said first set formed in said outer circumference of said disk-shaped portion of a first one of said first pole cores and said second set formed in said outer circumference of said disk-shaped portion of a second one of said first pole cores, each recess of said first set being angularly located between opposing N poles of an adjacent pair of said first permanent magnets, and each recess of said second set being angularly located between opposing S poles of an adjacent pair of said first permanent magnets.

12. An AC generator as claimed in claim 8, comprising;
a plurality of axially extending iron core insertion through-holes formed in said stacked-lamination core, each of said iron core insertion through-holes being located between an adjacent pair of said magnet insertion through-holes, and
a plurality of axially extending iron cores respectively contained in said iron core insertion through-holes.
